(19) United States
(12) Patent Application Publication
(10) Pub. No.: US 2014/0180893 A1
(43) Pub. Date: Jun. 26, 2014

(54) Methods and Systems For Generating A Mid-Point Periodic Mark Pool Tradeable Index

(71) Applicant: Curex Innovations LLC, (US)

(72) Inventors: William JP Dale, New York, NY (US); Dmitry A. Raykhman, Brooklyn, NY (US)

(73) Assignee: CUREX INNOVATIONS LLC, New York, NY (US)

(21) Appl. No.: 13/832,810

(22) Filed: Mar. 15, 2013

Related U.S. Application Data
(60) Provisional application No. 61/740,673, filed on Dec. 21, 2012.

(51) Int. Cl. G06Q 40/04

(52) U.S. Cl. CPC G06Q 40/04
USPC 705/37

(57) ABSTRACT

A computerized method provides periodic mark trading of financial instruments on a computerized trading system having one or more server computers. The method comprises at least one of the server computers: receiving a communication from a customer computer on a trading date, the communication including at least one periodic mark limit order, including at least an amount and an indication of a mark time at which a price will be determined for the at least one periodic mark limit order, and placing the received at least one periodic mark limit order in a periodic mark pool; calculating a periodic mark price from non-periodic mark orders on the book of an FX ECN; matching the received periodic mark limit order with a compatible other periodic mark limit order in the periodic mark pool; after the mark time, executing the matched received periodic mark limit order at the calculated periodic mark price.

### CROSS-REFERENCE TO RELATED APPLICATION

This application claims the benefit of U.S. Provisional Application No. 61/740,673, filed Dec. 21, 2012, the entire contents of which are incorporated herein by reference.

### FIELD OF THE INVENTION

The present invention relates to computer-implemented methods and systems for trading financial instruments. More specifically, the present invention relates to computer-based and computer-implemented systems and methods for generating a mid-point periodic mark pool tradable index that allows customers of a foreign exchange (“FX”) liquidity pool to leave orders to be executed at any specified Periodic Mark time at a Mid-point price, in which a definitive price discovery mark, a point in time when prices are known and available for execution, is created.

### BACKGROUND

Modern electronic trading systems have been developed for permitting electronic trading of various forms of securities. Electronic communications networks (ECNs) are electronic computerized trading systems that can automatically match buy and sell orders at specified prices. Typically, such trading systems permit large institutions, such as banks and security dealers to electronically post limit orders, i.e., bid and ask prices, for tradable items. The presence on the trading system of such posted rates provides liquidity to the trading system to, in effect, “make the market.” Thus, such participants are referred to as liquidity providers or market makers. Generally, the orders posted to the system by the liquidity providers are visible, persistent orders, that is, they are visible to other traders, and stay on the book of dealable orders until they are aggressed upon, i.e., hit or taken by liquidity consumers, unless they are withdrawn or modified before being hit or taken. In a typical scenario, the book of orders visible to consumers' displays the available orders with the best available prices of remaining orders toward the top of the book.

Market maker orders generally will be displayed in the system until the full quantity of the order is matched by one or more counter-orders and result in trade(s), or until the order is cancelled or modified by the market maker. Orders that are displayed on the order book are referred to as passive orders. Liquidity consumers have access to the book of orders currently on the system, for example via an electronic display showing all or part of the order book, the information of which is provided to the consumer by electronic communication with the trading system. Liquidity consumers can place orders that match with existing orders in the system. Liquidity consumer orders that are matched with existing passive orders are called aggressive orders. Aggressive orders are matched at the passive order price, with earlier orders getting priority over the orders that come in later.

The currency market represents one of the world's largest financial markets. One reason investors purchase foreign currencies is to manage foreign exchange risk exposure. For example, United States residents going to visit a European country on vacation have the risk that if the Euro (EUR) appreciates against the United States Dollar (USD), their vacation will be more expensive. Exporters who sell products in foreign currency have the risk that if the value of that foreign currency falls, then the revenues in the exporter's home currency will be lower. An importer who buys goods priced in foreign currency has the risk that the foreign currency will appreciate and make the local currency cost greater than expected.

Fund managers and companies who own foreign assets are also regularly exposed to changes in currency exchange rates. For example, a mutual fund manager who purchases foreign securities in a foreign currency for a mutual fund that is traded in a home currency must take into account fluctuations in currency exchange rates in managing the assets of the mutual fund. A large number of investors also invest in foreign currencies for speculative purposes, i.e., to profit from accurately predicting changes in currency rates.

In every foreign exchange transaction, one currency is purchased and another currency is sold. The currencies that are purchased and sold in a foreign exchange transaction are also referred to as a currency pair. A currency pair consists of a base currency and a reference currency. EUR/USD is an example of a currency pair. In this example, the base currency is EUR and its value remains constant at one EUR. The reference currency is USD. The value of the reference currency fluctuates up and down relative to the base currency. For example, if the EUR/USD currency pair is quoted at 1.1500, it means that one EUR costs USD 1.1500. Likewise, if the EUR/USD currency pair increases to 1.2000, the same EUR is now equivalent to USD 1.2000.

Currency transactions can be quoted in one of two ways: American-terms, in which a currency is quoted in terms of the number of United States Dollar per unit of foreign currency (e.g., how many USD to buy 1 EUR), and in European-terms, in which one United States Dollar is quoted in terms of number of units of foreign currency per dollar (e.g., how many Euro to buy 1 USD). The same logic can be applied to currency pairs in which the USD is not one of the currencies. Either currency can be expressed in terms of the other. However there are generally accepted conventions in the inter-bank foreign exchange marketplace that have been adopted by most of the foreign exchange marketplace. For example, the EUR/USD pair is quoted in American Terms and the Swiss Franc is quoted in European Terms.

In currency trading, a long position refers to entering into a contract to buy a base currency in exchange for a set amount of reference currency at a set time in the future. A trader may speculate that the price of a base currency will increase relative to the value of the reference currency by entering into a long position. A short position in currency trading means that the trader has entered into a contract to sell a set amount of base currency in exchange for a set amount of reference currency. A trader may speculate that the price of a base currency will decrease relative to the value of the reference currency by entering into a short position.

Foreign exchange (FX) transactions are offered over-the-counter as FX spot transactions or FX forward transactions. FX spot transactions are exchanges of one currency for another for immediate delivery. FX spot transactions are conducted at an exchange rate for immediate delivery known as the spot rate. Immediate delivery in the spot market generally settles in two business days, the settlement date is called the value date. The two day settlement period is necessary to allow for trade processing and for currency payments to be wired around the world.

FX forward transactions are exchanges of one currency for another at a future date. FX forward transactions are conducted at a forward rate, which is the exchange rate available at the time of the purchase of the FX forward transaction for exchanging currency at some specified date in the future. The forward rate is a function of both the spot rate and the difference in interest rates that could be earned in money markets or bond markets in the respective two countries. The difference between a forward exchange rate and a spot exchange rate represents the benefit or disadvantage an investor would experience should they convert in the spot market from one currency represented in the pair to the other and hold the new currency earning interest at a risk free rate in the bought currency and paying borrowing cost in the sold currency at a risk free rate. To the extent that there is an economic advantage associated with a higher interest rate in the new currency, such advantage is reflected in the price of the FX forward transaction. The discount or premium to the spot price in an FX forward transaction of the same pair is typically referred to as the “carry” or “cost of carry.”

The foreign exchange market operates five days per week on a 24-hour trade date basis beginning at 5 p.m. Eastern Standard Time (EST) Sunday. A trading day begins at 5 p.m. EST and ending the next day at 5 p.m. EST. For example, on a Monday, spot currencies are trading for value of Wednesday (assuming no holidays). At 5 p.m. EST on Monday, the trade date becomes Tuesday and the value date becomes Thursday. A position opened on Monday before 5 p.m. EST is either closed or rolled over to the next value date before the end of trading day on Tuesday. In this example, a one-day rollover involves the open position being rolled over from a value date of Wednesday to that of Thursday.

Rollover transactions are effectuated by making two offsetting trades that result in the same open position. However, when making rollover transactions, the rate at which a currency pair is quoted can change. These changes represent the difference in interest rates between the two currencies in the trader's open position applied in currency-rate terms (i.e., one day of “carry” or “cost of carry”). They constitute net interest earned or paid by the trader, depending on the direction of the trader's position. Assuming there is no change in the spot exchange rate for the currency pair, a trader can earn money in a rollover transaction if the trader holds a long position in the currency with the higher interest rate and holds a short position in the currency with the lower interest rate. Conversely, a trader can lose money in a rollover transaction if the trader holds a short position in the currency with the higher interest rate and holds a long position in the currency with the lower interest rate.

Exchange traded funds (ETFs) offer public investors an undivided interest in a pool of securities or other assets and thus are similar in many ways to traditional mutual funds, except that shares in an ETF can be bought and sold throughout the day like stocks on a securities exchange through a broker-dealer. Unlike traditional mutual funds, traders and investors participating in a secondary market can buy and sell ETFs without having to redeem their individual shares at net asset value, or NAV. Instead, financial institutions or other qualified investors purchase and redeem ETF shares directly from the ETF in the primary market, but only in large blocks. In the case of currency ETFs, financial institutions or other qualified investors convert currency holdings to shares that trade in a publicly tradable marketplace. It is recognized these have been developed and are substantially different from embodiments of the present invention.

In 2005, Rydex Investments launched the first ever currency ETF called the Euro Currency Trust (NYSE: FXE) in New York. Since then Rydex has launched a series of funds tracking all major currencies under their brand CurrencyShares. In 2008, Deutsche Bank's db x-trackers launched Sterling Money Market ETF (LSE: XGBP) and US Dollar Money Market ETF (LSE: XUSD) in London. Curex, in U.S. patent application Ser. No. 12/274,319, entitled Systems And Methods For Creation, Issuance, Redemption, Conversion, Offering, Trading, And Clearing A Debt Obligation Convertible Into Cash Plus A Spot Foreign Exchange Contract That Is Priced To Reflect The Value Of The Debt Obligation In A Base Currency In Relation To The Value Of A Reference Currency, which is hereby incorporated herein by reference, has proposed securities trading systems and methods for creating, issuing, offering, trading, redeeming, converting, and clearing a novel debt obligation convertible into cash plus a foreign exchange spot or forward contract that is priced to reflect the value of the debt obligation in a base currency in relation to the value of a reference currency. In the system, an order book server aggregates bid and offer information for the debt obligations. Best bid and offer information is communicated to one or more trading terminals. The trading terminals are capable of displaying best bid and offer and other information relevant to trading, redeeming, and converting the debt obligations in real time and allow a trader to trade, redeem, and convert C-Notes™ by interacting with the display on the trading terminal. The order book server and issuer calculate and track accrued interest on the debt obligations. Curex has also proposed, in U.S. patent application Ser. No. 12/750,670, entitled Hybrid OTC FX/FX ETF Primary Market Electronic Communication Network Technology Processing Systems And Methods For Offering, Trading, Issuing, Creating, Redeeming And Clearing Foreign Exchange Based Exchange Traded Funds And Creating, Calculating And Publishing Foreign Exchange Index And Tracking The Value Of Foreign Exchange Rates, which is hereby incorporated herein by reference, hybrid over-the-counter (OTC) foreign exchange (FX) exchange traded fund (ETF) primary market electronic communication network technology processing computer implemented methods and systems for creating, issuing, offering, trading, redeeming, converting, and clearing FX based ETF securities and indices valuing foreign exchange rates. An FX ETF distributor creates, offers, issues, and redeems FX ETF securities that are based on currency pairs or baskets of currencies. The FX based ETF securities are redeemable into cash or cash and an FX contract. Daily accrued net interest (“DANI”), which is the amount of accrued interest plus the daily cost of carry for rolling on a daily basis FX contracts that comprise FX ETF securities and gains or losses from roll transactions minus fees, is calculated and tracked. Real-time benchmark FX rate indices for currency pairs and baskets of currencies can be created using market data from the creation, issuance, trading, and redemption of the FX based ETF securities.

The global FX marketplace is estimated to transact over four trillion USD per day. Much of that volume is concentrated on a few pairs such as the EUR/USD, and USD/Japanese Yen. Rather than one centralized regulated marketplace, the global FX market consists of many fragmented, unregulated, over-the-counter pools of liquidity which can range from a single counterparty-to-counterparty market to a pool of liquidity providers competing for order flow from liquidity takers in an electronic order matching network. The nature of the fragmentation of the global FX marketplace means it is possible that a single currency pair can trade at different prices, in different markets at the same time. It is desirable for the purpose of price transparency, liquidity and market confidence to provide methods and systems to attract traders for purpose of transparent price discovery and to add liquidity to the global FX marketplace, especially in currency pairs that do not enjoy the liquidity that exists in major currency pairs such as that of the US Dollar, Euro and Japanese Yen.

In the foreign exchange market, there are many liquidity pools each comprising an electronic communications network (ECN) operated based on credit and trading relationships. These pools may be created and sponsored by liquidity providers, for example, market makers that are sizable holders of positions in particular currencies that facilitate the trading of those currencies to investors seeking to transact in currencies, who are liquidity consumers. Currency ETFs trade on exchanges, while spot and forward FX transactions trade over-the-counter (OTC).

A currency “basket” is a portfolio of selected currencies with different weightings. A currency basket is commonly used to minimize the risk of currency fluctuations. An example of a currency basket is the European Currency Unit that was used by the European Community member states as the unit of account before being replaced by the euro. Another example is the special drawing rights of the International Monetary Fund. Thus, a basket is a group of individual currency pairs that are treated as a single instrument. Curex has proposed, in U.S. application Ser. No. 13/733,006, entitled Methods And Systems For Automatic Index Rebalancing And Basket Trading, which is hereby incorporated by reference, computer-based and computer-implemented systems and methods for automatically executing and re-balancing real time or historical Foreign Exchange (FX) Indices expressed from FX Exchange Traded Fund (ETF) securities or debt instruments that are created by entering into an FX transaction and are convertible or redeemable into an FX contract, including indices or FX ETF securities based on baskets (groups of individual currency pairs that are treated as a single instrument). That application also relates to computer-implemented methods for automatically executing and rebalancing real time or historical FX Indices expressed from FX ETF securities or debt instruments based on baskets of one or more base currencies and two or more reference currencies that are also created by entering into FX contracts and redeemable or convertible into FX contracts.

There exist a number of methods to periodically determine current rates and prices in used valuing contracts and determining Net Asset Values (NAV) of various funds. However, these systems have numerous drawbacks. For one thing, the source of the prices used in calculating the periodic fixes, the prices that are used as a source, are not always available to the market participants to trade on. Further, different sources of pricing may have different time clocks, making it difficult, if not virtually impossible, to combine prices from different sources for a single fixing price.

Moreover, current systems that provide periodic price fixes have other limitations. For example, with regard to the source of pricing, current systems receive prices from various trading and dealing entities as well as various online trading platforms and ECNs. However, such an arrangement has associated problems. First, the prices, quotes and event reports of executed transactions are not verifiable. That is, there is no guaranty that any market participant could have been able to execute a trade at any of these prices. The reported prices may not have been tradable at all, or may have been available to only a select customer or group of customers. Further, such prices may be subject to abuse because of their lack of transparency.

In addition to the foregoing disadvantages, because there is no synchronization among the various providers of price information, data reported may be reported in such a way that would distort price fixing calculations. Also, because the current systems only calculate and publish fixed prices, no functionality is provided for a market participant to actually trade on these prices.

There is a need for a system in which, inter alia, prices can be provided in a transparent manner. There also is a need to provide a system by which periodically fixed prices can be traded in a liquidity pool, such as on an electronic communications network (ECN).

### SUMMARY OF THE INVENTION

In accordance with a first aspect of the present invention, a computerized method provides periodic mark trading of financial instruments on a computerized trading system having one or more server computers. The method comprises at least one of the server computers: receiving a communication from a customer computer on a trading date, the communication including at least one periodic mark limit order, including at least an amount and an indication of a mark time at which a price will be determined for the at least one periodic mark limit order, and placing the received at least one periodic mark limit order in a periodic mark pool; calculating a periodic mark price from non-periodic mark orders on the book of an FX ECN; matching the received periodic mark limit order with a compatible other periodic mark limit order in the periodic mark pool; and after the mark time, executing the matched received periodic mark limit order at the calculated periodic mark price.

In another aspect, order matching for each periodic mark starts at a predetermined start of matching period time.

In another aspect, the start of matching period time starts at one from among the group consisting of: (a) the beginning of the trading date; (b) the end of a previous mark time; and (c) as soon as a first periodic mark order is received for a new mark time.

In another aspect, the calculating of the periodic mark price comprises: during sampling time periods prior to and after the mark time, taking continuous available liquidity readings within a PIP Range from the top of the book of the FX ECN; and calculating a pip range average price (PipRAP) based on available liquidity.

In another aspect, the liquidity readings are taken every time there is a change in composition of the book of the FX ECN within the PIP Range from the top of the book, or, if there have been no changes since the previous reading, at a predetermined default time slice interval between readings.

In another aspect, the periodic mark price is calculated as an inverted weighted mid-point price using the following formula:

$${P}_{t}^{InvertedWeightedAverage} = \frac{{P}_{t}^{O} \times {V}_{t}^{B} + {P}_{t}^{B} \times {V}_{t}^{O}}{{V}_{t}^{O} + {V}_{t}^{B}}$$

Where:

“P” is the ECN FX Price

“O” is the Offer side

“B” is the Bid side

“V” is the Volume

“t” is the time of the Price

In another aspect, in a case when a customer's periodic mark order is not matched at the indicated mark period, the customer is given the option of: (a) cancelling the periodic mark order; (b) moving an unexecuted order to the next periodic mark; or (c) submitting the unexecuted order to the FX ECN for trading.

In another aspect, the periodic mark liquidity pool operates as a dark pool in which the participants do not know what kind of orders other customers are placing in the pool.

In another aspect, the periodic mark liquidity pool operates as a grey pool, in which a customer's orders are matched continuously against other customers' orders during a matching period and customers with orders in the periodic mark pool are informed if their orders are matched against other customer orders and only awaiting determination of the price at the mark time.

In another aspect, the periodic mark order may be a basket order.

In another aspect, for a basket order the mark price for each periodic mark time will be calculated using periodic mark prices calculated for the same periodic mark time for the basket's underlying currency pairs.

In another aspect, credit for a customer is reserved for the customer orders when a periodic mark order is placed.

In another aspect, credit is verified at a time of matching a customer's periodic mark order.

In accordance with another aspect of the present invention, a computerized trading system has one or more server computers for providing periodic mark trading of financial instruments. The one or more server computers are configured and programmed to: receive a communication from a customer computer on a trading date, the communication including at least one periodic mark limit order, including at least an amount and an indication of a mark time at which a price will be determined for the at least one periodic mark limit order, and place the received at least one periodic mark limit order in a periodic mark pool; calculate a periodic mark price from non-periodic mark orders on a book of an FX ECN; match the received periodic mark limit order with a compatible other periodic mark limit order in the periodic mark pool; and after the mark time, execute the matched received periodic mark limit order at the calculated periodic mark price.

In another aspect, order matching for each periodic mark starts at a predetermined start of matching period time.

In another aspect, the start of matching period time starts at one from among the group consisting of: (a) the beginning of the trading date; (b) the end of a previous mark time; and (c) as soon as a first periodic mark order is received for a new mark time.

In another aspect, the calculating of the periodic mark price comprises: during sampling time periods prior to and after the mark time, taking continuous available liquidity readings within a PIP Range from the top of the book of the FX ECN; and calculating a pip range average price (PipRAP) based on available liquidity.

In another aspect, the liquidity readings are taken every time there is a change in composition of the book of the FX ECN within the PIP Range from the top of the book, or, if there have been no changes since the previous reading, at a predetermined default time slice interval between readings.

In another aspect, the periodic mark price is calculated as an inverted weighted mid-point price using the following formula:

$${P}_{t}^{InvertedWeightedAverage} = \frac{{P}_{t}^{O} \times {V}_{t}^{B} + {P}_{t}^{B} \times {V}_{t}^{O}}{{V}_{t}^{O} + {V}_{t}^{B}}$$

Where:

“P” is the ECN FX Price

“O” is the Offer side

“B” is the Bid side

“V” is the Volume

“t” is the time of the Price

In another aspect, in a case when a customer's periodic mark order is not matched at the indicated mark period, the customer is given the option of: (a) cancelling the periodic mark order; (b) moving an unexecuted order to the next periodic mark; or (c) submitting the unexecuted order to the FX ECN for trading.

In another aspect, the periodic mark liquidity pool operates as a dark pool in which the participants do not know what kind of orders other customers are placing in the pool.

In another aspect, the periodic mark liquidity pool operates as a grey pool, in which a customer's orders are matched continuously against other customers' orders during a matching period and customers with orders in the periodic mark pool are informed if their orders are matched against other customer orders and only awaiting determination of the price at the mark time.

In another aspect, the periodic mark order may be a basket order.

In another aspect, for a basket order the mark price for each periodic mark time will be calculated using periodic mark prices calculated for the same periodic mark time for the basket's underlying currency pairs.

In another aspect, credit for a customer is reserved for the customer orders when a periodic mark order is placed.

In another aspect, credit is verified at a time of matching a customer's periodic mark order.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating structural components of an electronic trading environment in which embodiments of the present invention are implemented.

FIG. 2 is a flow diagram illustrating trading of periodic mark orders.

FIG. 3 is a flow diagram illustrating the calculation of periodic mark prices in accordance with one embodiment of the present invention.

FIG. 4 is a diagram representing an exemplary order entry screen GUI in accordance with an aspect of the present invention.

### DETAILED DESCRIPTION

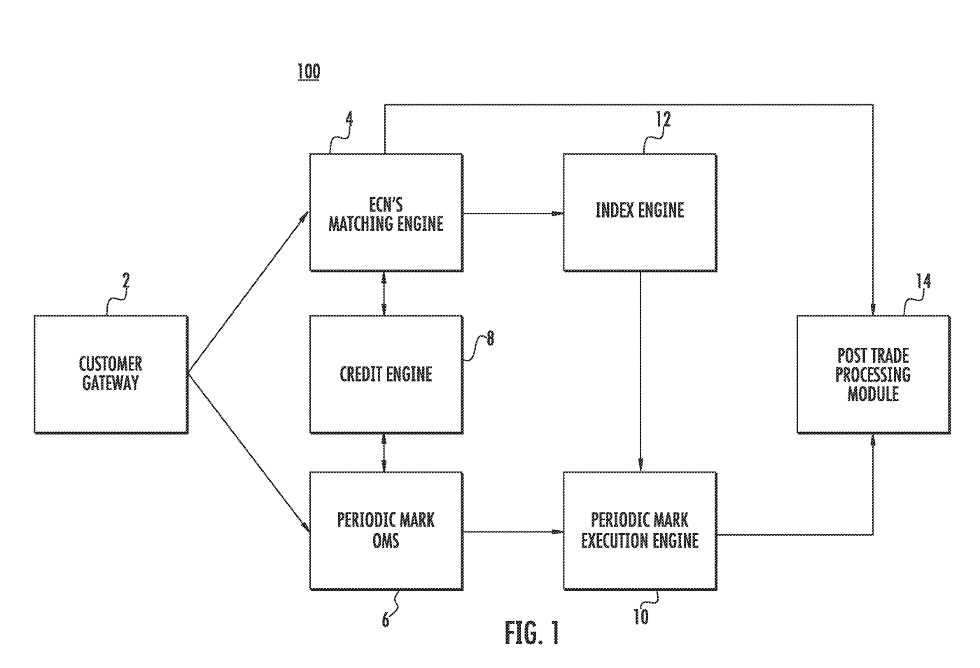

The following description will be made with reference to FIGS. 1 to 4.

The system of the present invention utilizes a computer hardware and software system to calculate a periodic mark price index and permit customers to leave orders in a liquidity pool to be executed at any specified periodic mark time at that periodic mark's specific calculated index price.

The exact time and number of these events will preferably be constant for each index and will be set up ahead of time as part of an index methodology. The time of these marks can be set up as equal time intervals or it can be coordinated with different outside market events.

For example, in preferable illustrative embodiments, hourly, half hourly and quarter hourly marks. However, the invention is not limited to these example time periods. Alternatively or in addition, marks may be set to correspond to closing and opening times of various Securities Exchanges around the world, or set to correspond with other significant market events, including but not limited to End of Day (EOD) time or Net Asset Value (NAV) calculation time for various securities, and Exchange Traded Funds (ETFs), Valuation points for Exchange Traded Notes, Futures, Options, structured products, etc.

Whichever of the above events or periods are selected, the result is to create definitive price discovery marks, points in time when prices are known, set by legitimate market participants, not susceptible to manipulation and available for quick execution with minimal delay. These calculations and prices used in these calculations will come from a liquidity pool, in which orders are actually traded, such as the Cürex Index Liquidity Pool, where all the participants already required to act based on the strict set of rules. Preferably, all activities in such a pool are also monitored and audited by an independent third party index publishing body.

As part of the present invention, in addition to calculating a periodic mark index price, a computerized hardware and software tradable system is provided in which customers can leave orders to be execute at these mark events, and once each periodic mark index price is calculated and published the system will execute matching orders.

It is contemplated that directly connecting periodic mark price calculation computer systems with computer systems responsible for collecting customer's periodic mark orders, and executing these orders as soon as the periodic mark index prices are calculated, without the necessity of manual interruption or delay, will create a new and novel way of trading and utilizing the periodic mark price indices.

It is an independent object of this invention to provide an improved method of determining a periodic fixing price for currencies, stocks, commodities or other financial instruments. It is also an independent object of this invention to provide a computerized method and apparatus programmed and configured to determine such fixing prices with transparent, identifiable price sources, where the price sources are available for trading to the customers of periodic fixings, where the values that go into the calculations of the periodic fixings and the algorithms of these calculations are available to all market participants and these calculations are designed in such a way that makes it difficult to manipulate or influence the periodic fixing prices. It is further contemplated that a market place will be established in conjunction with the periodic fixing calculation where customers will be able to leave buy and sell orders to be executed at the fixing price.

Where other systems use various pricing sources some tradable and some not this invention calls on using a single index liquidity pool where all participants, liquidity providers and liquidity consumers operate by published set of rules. All prices published in the index liquidity pool during the fixing sampling time are tradable and used in determining the fixing price. There is no subjective filtering or selective blocking or sorting of market participant prices that goes into determining the fixing price.

### DEFINITIONS

Periodic Mark—periodic times of the day when the system will calculate mark price indices.

Matching Period—period of time prior to each periodic mark event when a customer's order can be matched with another order.

Benchmark Index—indices published as continuous streaming indices.

FX ECN Index Liquidity Pool—a liquidity pool where all participants are acting based on established rules and where all published prices and trade executions are used as source of index calculation, e.g., for the benchmark index.

C/R—an application designed to provide create/redeem functionality for currency based ETFs, ETNs, and other structured products.

AP—Authorized Participant, financial institution authorized to participate in the primary C/R market.

Fund—fund holding underlying securities for the ETFs, ETNs and structured products.

Auto-Rebalancing—an application designed to provide automated rebalancing functionality, e.g., for baskets.

FIG. 1 is a diagram of an exemplary computerized trading environment 100 in which the present invention operates. The trading environment 100 utilizes several server computers/engines to perform various required functions. Customer gateway 2 is configured and programmed to permit a customer to connect to the server computers to communicate orders for traditional trades on an ECN, as well as orders for periodic mark event trading in accordance with the present invention. Orders entered by the customer on customer gateway 2 are routed, e.g., via electronic messages, either directly to a matching engine 4 of the ECN for the trading of regular orders on the ECN, or, for periodic mark trading orders, first to a periodic mark order management server (OMS) 6. In a preferred embodiment, an ECN would be modified to include the components shown in the figure. Alternatively, the additional components may be separate from the ECN and communicate with the ECN as necessary.

The ECN's matching engine 4 would typically be a regular matching engine of the type used to execute traditional real time trading orders, such as FX orders for trading in an FX ECN. The periodic mark OMS 6 is configured and programmed to perform the calculations and communications necessary for periodic mark trading. In particular, the periodic mark OMS is configured and programmed to hold all pending periodic mark orders, validate the orders, match the orders and process all requests to cancel or modify orders. As will be discussed in more detail below, at the mark time, matched periodic mark orders will be submitted for execution processing to the periodic mark execution engine 10.

Credit engine 8 is configured and programmed to perform credit checking relating to a customer, e.g., vis a vis potential counterparties to trades, and to reserve credit required to perform periodic mark trades. Preferably, the credit engine will be a credit module of an associated FX ECN, such as the credit module used by the Cürex FX ECN, which is described in U.S. patent application Ser. No. 12/750,670, which is hereby incorporated by reference in its entirety.

Periodic mark execution engine 10 is configured and programmed to process all matched periodic mark orders. In the system of the present invention, the price that will be applied to matched orders is determined at each mark time. The periodic mark execution engine 10 receives the price calculated for the present mark from the index engine 12 and receives all matched orders from the periodic mark OMS 6. The periodic mark execution engine 10 processes all the matched orders so as to, e.g., apply the prices for the current mark time, and passes execution information to the post trade processing module 14.

Index engine 12 is configured and programmed to calculate a periodic mark index price. The index engine 12 monitors prices of orders trading on the ECN, for example an FX ECN, and uses prices from the ECN's matching engine 4 to calculate a periodic mark index price based on number of price readings. The number and exact time of these readings will be determined by an index methodology. Illustrative processes for determining the periodic mark index price are discussed in detail below. Post trade processing module 14 is configured and programmed to perform all post trade activities, including trade reporting, confirmations and alerts.

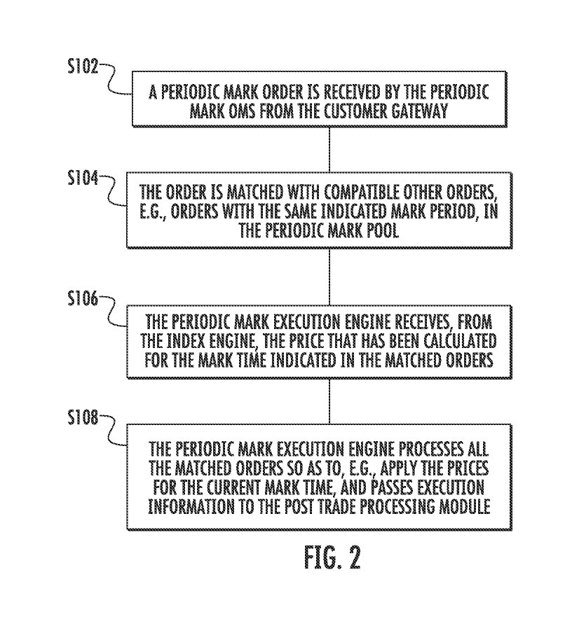

FIG. 2 is a flowchart showing the steps for submission, matching and execution of periodic mark trades in accordance with an aspect of the present application. In step S102, a periodic mark order is received by the periodic mark OMS 6 from the customer gateway 2. A periodic mark order includes an amount as well as an indication of the mark period at which the price is to be applied to the order. Unlike a typical order, the periodic mark order does not include a price. The customer, in submitting the order, is expressing his desire to buy/sell a certain amount, e.g., of currency, at a price determined at the indicated mark period. So, for example, if the mark periods are on the quarter hour, the order might include an indication that it is to be executed at the price determined by the system for, e.g., the 1:15 PM mark time.

At Step S104, the order is matched with compatible other orders, e.g., orders with the same indicated mark period, in the periodic mark pool. Details of matching criteria are discussed in more detail below. Note that while the price will not be determined until the indicated mark time, the periodic mark OMS 6 will be able to match the orders based on, e.g., the amount indicated in the order, with other orders with the same indicated mark period.

At Step S106 the periodic mark execution engine 10 receives, from the index engine 12, the price that has been calculated for the mark time indicated in the matched orders. This price is applied to the matched orders, which have been received from the periodic mark OMS 10 to book the trade. The periodic mark execution engine 10 processes all the matched orders so as to, e.g., apply the prices for the current mark time, and passes execution information, at Step 108, to the post trade processing module 14.

Using the structure described above, in accordance with an embodiment of the present invention, a new index liquidity pool, i.e., a periodic mark pool is created, in which orders may be placed to be matched at a mark price that is determined relative to the mark time. These events will take place periodically, and the exact time and periodicity of the marks could be different for, e.g., different indices that may be used for price determination. To increase transparency to a user of the system, the exact time and periodicity for each index are published as part of an index methodology.

For the purpose of illustration, the periodic mark event functionality system will be described using quarter hour marks. In such an exemplary embodiment, quarter hour marks take place every quarter hour, e.g., at 00, 15, 30 and 45 minutes of every hour throughout each trading day.

In an embodiment of the present invention, the periodic mark prices will be published as periodic mark indices. As a separate embodiment, executions in periodic mark events can also be published as part of the periodic mark index or it can be published as a separate index.

In a preferred embodiment, periodic mark tradable events will be FX transactions and will be supported for all single currency orders supported by the FX ECN. Preferably, the system also provides functionality for period mark orders relating to currency basket instruments.

In a preferred embodiment, the periodic mark pool is constructed in conjunction with a regular FX ECN, and all customers participating in the regular FX ECN liquidity pool will be able to place periodic mark order in the periodic mark pool utilizing the same credit accounts he/she had in the regular FX ECN liquidity pool.

To integrate periodic mark trading on a conventional FX ECN, a new order type will be created, which will be referred to as a periodic mark limit order, or simply a “periodic mark order,” which specifies an amount, but not a price. A customer will be able to leave these periodic mark orders specifying that the order is to be executed at the periodic mark index price at a specified periodic mark time.

It is envisioned that there will be many periodic marks events for each index during the day. For example, in the case of quarter hour mark there will be 96 mark events for each currency pair or basket each day.

The periodic mark price index will be calculated for each of the periodic marks using a methodology to be described below. It is noted that periodic mark trading does not provide a guaranty that any orders submitted to be executed at any one of the periodic mark events will be actually executed. Order execution will only occur if there are buyers and sellers expressing interest in transacting at a specified periodic mark event. If so, the system would match and book these trades.

Different types of periodic mark limit orders may be implemented in accordance with the present invention. For example, in various embodiments customers will be able to place periodic mark limits orders as both day orders and good till canceled (GTC) orders. In another variation, the system would be configured and programmed to permit customers to place new periodic mark orders only after the previous periodic mark event had ended.

In one embodiment, all customers placing the periodic mark limit orders will have only one type of transaction fees, there will be no distinction between aggressive or passive orders. Preferably, no distinction will be made between liquidity providers and liquidity consumers for these periodic mark orders. All participants participating in these periodic mark events will be charged the same transaction fees when the orders are executed. Preferably there will be no distinction between adding liquidity or consuming liquidity for these periodic mark orders. However, as a separate embodiment there may be a distinction between liquidity providers and liquidity consumers leaving periodic mark limit orders, and they may be charged different transaction fees.

Preferably, a periodic mark limit order will have a minimum time-to-live parameter. This parameter will be configurable but initially the minimum time-to-live parameter will be set to, e.g., one (1) minute (Any order will have to be left in the system for at least one (1) minute before it can be canceled.)

The periodic mark pool in accordance with the present invention can, in accordance with an exemplary embodiment, be operated as a “dark pool” in which none of the participants know what kind of orders other customers are placing in this pool. In this scenario, only at the mark time, when the orders are executed, would the system report back to the customer if their orders were executed or not.

In case of a dark pool, none of the customer orders are matched until the mark time. At the mark time customer buy and sell orders will be matched on FIFO (first in first out) basis. Preferably, all orders in this dark pool can be canceled at any time prior to the mark time.

As an additional embodiment, the periodic mark pool will be operated as a “grey pool,” in which a customer's orders will be matched continuously against other customers' orders during the matching period. In such a grey pool, customers who are placing orders into this pool will be informed if their orders are matched against other customer orders and just awaiting for the price to be determined at the time of the Mark.

In accordance with a preferred embodiment, periodic mark limit orders will have a minimum view amount. In an exemplary embodiment, these amounts will be 10 (ten) million notional, but these amounts may be different for different currency pairs. These minimum view amounts will preferably be implemented as customizable parameters, e.g., by management. Only participants with orders having order amounts that are higher than or equal to the minimum view amount will be able to see the aggregated unmatched interest in the same periodic mark limit event and will be notified if their orders have been matched.

In this embodiment, customers will be allowed to place periodic mark limit orders with amounts less than minimum view amount. However, these customers will not be able to see the aggregated unmatched interest in the periodic mark event and will not know until the mark time if their orders were matched.

Order matching and cancelations:

According to a preferred embodiment, all order matching functionality for each periodic mark will start at the specified start of matching period time. The start of matching period time can start at the beginning of the trading date. Alternatively, the start of matching period time can start at the end of the previous periodic mark (e.g., 15 minutes prior to each mark in case of the quarter hour marks). In another alternative, the matching period can start as soon as the first periodic mark order is placed for a new mark

As an alternative embodiment, the matching period can start as a specified time period prior to the each mark time. For instance, the matching period can start 10 minutes prior to the mark. Generally, this period in which the system, and in particular, the periodic mark OMS 6, will be matching submitted orders will be referred to as the periodic mark order matching period.

When a new periodic mark limit order is entered, the periodic mark OMS 6 will try to match it with unmatched pending periodic mark limit orders entered on the opposite side of the book (e.g., buys will be matched with sells). If there is a match, the two orders in the match are considered “matched and reserved” and these orders cannot be canceled anymore. These orders are matched and are awaiting the periodic mark price to be published to finish the order booking process.

When orders are matched system will send notifications to both customers in the match, i.e. notifications that their order is matched pending periodic mark match price.

In a preferred embodiment, pending periodic mark limit orders can be canceled only if these orders have not been matched. If there is a partial match, i.e., where there is an opposite order but the opposite order only covers part of the customer's order, only the unmatched portion of the customer's order may be canceled. The rest of the customer's order is considered matched and reserved.

If a customer makes a mistake entering a periodic mark limit order and realizes it only after the order is already matched there is no option to cancel this order. The only option for the customer would be to enter a new periodic mark order in the opposite direction and wait for the second order to be matched. Alternatively, the customer can wait for the first periodic match order confirmation and close that order in the regular FX ECN Index Liquidity Pool.

In a preferred embodiment, all periodic mark unmatched orders for each periodic mark will be aggregated and the aggregated outstanding unmatched amounts of buy or sell periodic mark limit orders will be published in real time to all participants with open (unmatched) orders in this periodic mark pool event that meet minimum requirements. Only the unmatched information relevant to each customer will be published. The system is configured and programmed to permit periodic mark pool customers to submit an order opposite to the published unmatched interest, in which case it is matched but not executed until the price is determined at the next price mark. The unmatched amount that has to be matched ahead of the customer's own orders will be published.

Preferably, the system will only show the unmatched amount for each periodic mark event. For instance if there is 100M on the bid side and 220M on the offer side, 100M would be matched and system will only show, e.g., via the customer's graphical user interface (GUI), to be described in more detail below, unmatched 120M on the offer side.

Preferably, only participants with orders in which the order amounts are higher than or equal to the minimum view amount will be able to see the aggregated unmatched interest in the same periodic mark limit event.

Liquidity providers on the regular FX ECN can put their own interest on the system as periodic mark limit orders, but they will be treated as regular customers for periodic mark limit orders. Including being charged transaction fees.

In a preferred embodiment, the periodic mark pool will be implemented in conjunction with an FX ECN. In such a case, liquidity providers preferably would have to have different accounts set up on FX ECN. These special accounts will be able to connect to FX ECN using either a client API gateway or client UI of the FX ECN (not shown).

Credit.

Two possible solutions with regard to credit requirements for such periodic pool trading are discussed below.

In a first preferred embodiment, credit is reserved. In this scenario credit will be reserved at the time these periodic mark limit orders are placed. Specifically, when a periodic mark limit order is placed by a customer, the system, in particular the credit engine 8, calculates credit requirements for such order and reserve the calculated credit. Because credit has to be reversed for these types of orders and the actual amount of credit required at the time of execution may be different from the amount reserved, credit engine 8 reserves an additional credit.

Additional credit will be represented as a percentage of the net credit required. As an example, an extra 10% of calculated credit can be reserved. The extra percentage of credit may vary by currency pair and will be set as a parameter. Once trade price is determined and trade is booked system will recalculate credit utilization and release unused extra credit. Credit reserve will also be released if the order is canceled. Once periodic mark orders are executed these orders will be netted with other executions, including non periodic mark executions, on the FX ECN for the same Credit Account/same value date.

In a second preferred embodiment, credit is not reserved. Rather, credit availability is verified by the credit engine 8 at the time of matching the periodic mark limit orders. When placing a periodic mark limit order, the credit engine 8 calculates credit requirements for such order and checks credit availability at that time. If required credit is available the order will be placed. The credit engine 8 calculates credit requirements based on the prices available in the FX ECN Index Liquidity Pool at the time of placing this order and makes sure that 100% of the required credit is available. As an additional parameter the credit engine 8 system checks for an extra credit. The extra credit will be, e.g., represented by the percentage of the net credit required. Credit however will not be reserved, it will be checked and the order will be placed if the required credit is available.

At the time of performing the match in the periodic mark pool the credit engine 8 checks the required credit availability again, but now the credit check is performed based on the prices available in the FX ECN Index Liquidity Pool at the time of the match. If the mark price is already available, i.e., has already been calculated, at the time of the match system will use the calculated mark price instead. If customer doesn't have the required credit available customer's order will not be matched and will be canceled instead. Cancelation of unmatched periodic mark orders will have no effect on the available credit.

Once periodic mark orders are executed these orders will preferably be netted with other executions on the FX ECN, including non-periodic mark executions, for the same trading Account/same value date.

It is possible that a prime broker could ask to pull the credit for a customer participating in the periodic mark events. If the customer has unmatched periodic mark limit orders, these orders will be canceled and customer's credit can be pulled. If the customer has matched periodic mark limit orders these orders can only be canceled, and the match can only be broken, when credit of one of the participants in the match is pulled by their prime broker, subject to legal agreements between the parties.

As an embodiment, both Dark and Grey Pools may be operated without implementing credit checking functionality.

Periodic Mark price calculation methodology.

As part of this invention it is contemplated to use the following algorithm to calculate the Mark Price:

Parameters:

Sampling time period prior to the mark—time period prior to the mark when price sampling will be taken.

Sampling time period after the mark—time period after to the mark when price sampling will be taken.

Sampling PIP Range—only prices in this pip range (Market Depth) from the top of the book will be used by the index engine 12 in calculating quarter hour mark volume weighted average price (VWAP) index values.

Time Slices Reading—time slice interval between the readings during the sampling periods.

Notional Amount—the notional amount of the index.

Skew—customers will be able to request rebalancing execution to be done at the index price with agreed upon skew. Skew will be used to define the transaction fee counter parties can charge customers interested in basket rebalancing.

Algorithm:

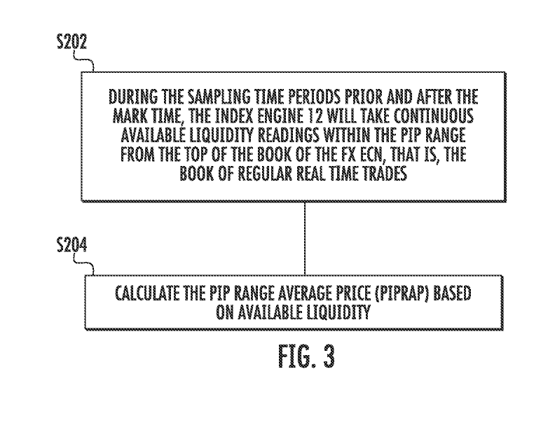

FIG. 3 is a flow chart illustrating an algorithm for calculating the periodic mark priced, in accordance with one embodiment of the present invention. In the illustrated embodiment, the index engine 12 is configured and programmed to perform the algorithm. At Step S202, during the sampling time periods prior and after the mark time, the index engine 12 will take continuous available liquidity readings within the PIP Range from the top of the book of the FX ECN, that is, the book of regular real time trades and, at Step S204, calculate the pip range average price (PipRAP) based on available liquidity. The index engine 12 will take the sample PipRAP reading every time there is a change in the book composition or if there were no changes from the previous reading at next time slice reading event. Alternatively, instead of using the PIP Range parameter the index engine 12 can use the notional amount of the base currency in the currency pair and calculate the VWAP price for the specified notional amount.

If there was at least one price sample taken after one time slice but before the next one, there will be no reading taken at that second time slice.

There will be readings taken at every execution time for trades on the FX ECN, the matched orders will be used as part of corresponding bid and offer lists.

After the sampling period ends, at Step S206, the index engine 12 calculates VWAP bid and VWAP offer prices by using all PipRAP calculated for all readings.

As an example, the quarter hour mark price is calculated as an inverted weighted Mid-Point price using the following formula:

$${P}_{t}^{InvertedWeightedAverage} = \frac{{P}_{t}^{O} \times {V}_{t}^{B} + {P}_{t}^{B} \times {V}_{t}^{O}}{{V}_{t}^{O} + {V}_{t}^{B}}$$

Where:

“P” is the ECN FX Price

“O” is the Offer side

“B” is the Bid side

“V” is the Volume

“t” is the time of the Price

Preferably, the quarter hour mark price will be adjusted to the market convention precision and will be published with predetermined publication delay.

As an alternative embodiment, the index engine 12 instead is programmed and configured to use the following calculation algorithm to calculate another type of mark price. In this alternative embodiment the index engine 12 will take multiple readings, some before the mark, during and after the mark. The exact number of readings may differ from instrument to instrument and can be changed from time to time.

At the time of each periodic mark the index engine 12 will calculate the periodic mark index price. For example, to calculate the quarter hour mark price, the index engine 12 could take 5 readings:

Take five (5) readings of a FX ECN Benchmark Spot FX 1M VWAP bid and five (5) readings of 1M VWAP offer prices. The index engine 12 will take these readings at the following times: two (2) seconds prior to the mark, one (1) second prior to the mark, at the mark time, one (1) second after the mark, two (2) seconds after the mark. Each of these readings will be taken at random, within +/−250 ms of specified time. The number of these readings and time interval between the readings will be set as configurable parameters and can be changed from instrument to instrument or from time to time. The index engine 12 will calculate separately equal weighted average bid and average offer prices using these five readings and the mid-point periodic mark index price will be calculated as a mid-point between these two average prices. The above calculations allow publication of Bid, Offer and Mid-Point Index Prices.

In accordance with an advantageous aspect of the present invention, the matching of the periodic mark orders can be performed by the periodic mark OMS 6 before the periodic mark index price is determined. As discussed above, the periodic mark orders, instead of indicating a price, contain an indication of at which mark period the price for the order is to be determined. At the time of the periodic mark, once the mark price is determined, the periodic mark execution engine 10 will process all matched buy and sell orders using this periodic mark index price.

To account for the case in which an order is not matched in the specified periodic mark, customers are able to provide instructions, prior to the match event, as to how to deal with any unexecuted portion of the periodic mark limit orders.

Options include: (a) cancelling the order; (b) moving the unexecuted order to the next periodic mark; or (c) submitting order to the FX ECN Index Liquidity Pool using any other existing FX ECN order types (limit, VWAP, TWAP, etc.).

Preferably, a periodic mark limit price index will be published at each periodic mark event whether there are executions or not. These indices will be published with a specified delay. The exact duration of the delay will be configured in the index engine 12.

In the case in which the functionality is provided in conjunction with that of an FX ECN, it is preferable if customer can participate in periodic mark events under the same trading ID as used in their “regular” trading on the FX ECN.

The periodic mark index prices can be used not only for trading in the periodic mark pool, but also in various other processes, as valuation points. In particular, the techniques of this invention for generating the Periodic Mark Index Prices in implementing Create/Redeem functionality of the FX ETF Securities described in U.S. patent application Ser. No. 12/750,670.

For example, preferably, for 40 Act ETFs EOD C/R FX Transfer orders the system will use the end of day (EOD) Periodic Mark price calculated according to the present invention. These orders will be placed into a separate periodic mark liquidity pool. This liquidity pool will have the order matching period from the beginning of the day to the end of the day. These orders will be placed into this periodic mark pool as matched pairs between AP and the Fund at any time during the day without any limitations of the order matching period.

Customers of the Create/Redeem functionality will preferably be able to place Periodic Mark Cash Only C/R orders just as any other C/R orders (TWAP, VWAP, etc.) under the same ID.

Rebalancing Process

Periodic Mark processes are also particularly applicable for use in the rebalancing process relating in auto balancing of baskets, for example as described in U.S. application Ser. No. 13/733,006, discussed above.

In such case, rebalancing orders used for rebalancing the baskets could be matched with other orders placed into the specified periodic mark. Preferably, the periodic mark events will also be available in the basket books. As such, customers will be able to submit periodic mark basket orders.

All the functionality with regard to order management, credit and dealing with unexecuted orders, available in a single currency pair books, as discussed above, will be available in basket books. In this context, when a customer's periodic mark basket orders are executed, trade execution messages will be sent to corresponding customer Prime Brokers. These messages will specify all component trades relating to the basket and not the basket trades for prime brokers.

In an additional aspect, the periodic mark price for baskets will be calculated using the periodic mark prices for all underlying currency pairs.

When a customer order is submitted to the basket periodic mark pool, the system will try to match incoming basket order against existing unmatched periodic orders in this basket periodic mark pool and if there is no match, the system will try to match individual basket component orders in all the component books. If there are matches in all basket component periodic mark pools, the system will place the component orders into all the component books and match these orders against existing unmatched orders in these component books. The component orders should be matched only if system can match all the component orders right away.

After all periodic mid-point prices are published and all component trades are booked, the basket trade is recorded and basket trade confirmation is sent to the customer. If neither of the match attempts were successful, the unmatched basket order will be placed into the basket periodic mark pool.

With regard to mid-point basket price calculation, for baskets the mid-point price for each periodic mark event will be calculated using the mid-point prices calculated for the same periodic mark event for the underlying currency pairs. Once all the mid-point prices for the same periodic mark event for the underlying currency pairs are calculated, the mid-point basket price will be calculated using the standard basket methodology formula for that basket. When the customer's periodic mark basket orders are matched, system will send trade execution messages to corresponding customer prime brokers. These messages will specify all component trades and not the basket trades for prime brokers.

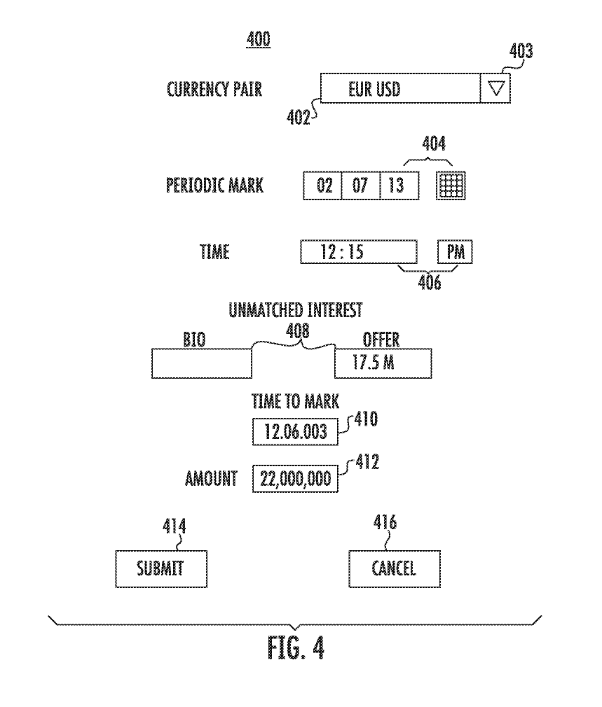

Preferably, the customer gateway 2 will provide the user with a real time screen/interface (order entry window) to manually exercise any of the options described here. An example of such a screen/interface (order entry window) 400 is described below with reference to FIG. 4.

The currency pair window 402 allows customers to choose, via drop down menu tab 403, the currency pair they want to trade. The period mark window 404 permits the customers to choose the date of the periodic mark to be used for an order to be entered using the screen/interface 400. The periodic mark time window 406 permits the customers to choose the time of the periodic mark, e.g., from a list of supported times (e.g., every quarter hour). The unmatched interest windows 408, including a bid window and an offer window, display the unmatched amount for the selected periodic mark event. As discussed above, because only the amounts that are unmatched are shown, usually only one of the bid and offer windows would display an amount at any given time. The time to mark window 410 shows a countdown to the selected mark time. The amount window 412 displays and permits entry of the amount of the periodic mark order desired by the customer. The submit button 414 permits the customer to submit a periodic mark order corresponding to the fields entered above. The cancel 416 button permits the customer to cancel a periodic mark order without submitting it.

The above described environment 100, including, e.g., the components periodic mark OMS, and periodic mark execution engine, preferably functions as an “add-on” to an existing FX ECN, such as the Cürex FX ECN, shown as element 80 in pending U.S. patent application Ser. No. 12/750,670, entitled Hybrid OTC FX/FX ETF Primary Market Electronic Communication Network Technology Processing Systems And Methods For Offering, Trading, Issuing, Creating, Redeeming And Clearing Foreign Exchange Based Exchange Traded Funds And Creating, Calculating And Publishing Foreign Exchange Index And Tracking The Value Of Foreign Exchange Rates, filed Mar. 30, 2010, which is hereby incorporated by reference in its entirety. However, the computerized system of the present invention could also be used with other trading systems.

The above-described system as represented in the figures, and the other structures described hereinafter, can be implemented in digital electronic circuitry, or in computer hardware, firmware, software, or in combinations of them. The implementation can be as a computer program product, e.g., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network and messaging platform.

Method steps as described herein can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Machine readable storage devices suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (“IC”), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (“PBX”). In any of these cases, implementation may be achieved either by writing applications that are native to the chosen platform, or by interfacing the platform to one or more external application engines.

To provide for interaction with a consumer, computer terminals that may be associated with the OTC FX clients, can be computers having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition or alternatively, a Trade Execution API can be connected to customer's Order Management System (OMS) where trade orders can be initiated and information returned from the gateway 104 can be displayed.

The above described system can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components.

The components of the system described above can be interconnected by any form or medium of digital data communications, e.g., a communications network. Examples of communication networks, also referred to as communications channels include a local area network (“LAN”) and a wide area network (“WAN”), e.g., the Internet, and include both wired and wireless networks. Unless clearly indicated otherwise, communications networks can also include all or a portion of the PSTN, for example, a portion owned by a specific carrier.

The computing environment shown in, e.g., FIG. 1 as described above includes clients and servers. A client and server are generally remote from each other and typically interact through a communication network. The relationship of client and server arises by virtue of computer programs running on the respective computers and having a client-server relationship to each other, communicating using standard communication messages understood by both clients and servers.

As noted above, the methods and systems described above can be implemented with trading systems or Electronic Communication Networks (ECN) for trading any financial instrument, including currency, and are not limited to trading currencies.

For example, the methods and systems described above can be implemented with the methods and systems described in co-pending applications of commonly owned by Applicants' assignee, including, U.S. patent application Ser. No. 12/750,670, entitled Hybrid OTC FX/FX ETF Primary Market Electronic Communication Network Technology Processing Systems And Methods For Offering, Trading, Issuing, Creating, Redeeming And Clearing Foreign Exchange Based Exchange Traded Funds And Creating, Calculating And Publishing Foreign Exchange Index And Tracking The Value Of Foreign Exchange Rates, filed Mar. 30, 2010, and U.S. patent application Ser. No. 12/274,319, entitled Systems And Methods For Creation, Issuance, Redemption, Conversion, Offering, Trading, And Clearing A Debt Obligation Convertible Into Cash Plus A Spot Foreign Exchange Contract That Is Priced To Reflect The Value Of The Debt Obligation In A Base Currency In Relation To The Value Of A Reference Currency, filed Nov. 19, 2008. The entire contents of each of these applications is incorporated by reference herein.

The invention has been described in terms of particular embodiments. The alternatives described herein are examples for illustration only and not to limit the alternatives in any way. The steps of the invention can be performed in a different order and still achieve desirable results. It will be obvious to persons skilled in the art to make various changes and modifications to the invention described herein. To the extent that these variations depart from the scope and spirit of what is described herein, they are intended to be encompassed therein. It will be understood by those skilled in the art that various changes in form and details may be made therein without departing from the scope of the invention encompassed by the appended claims.

What is claimed is:

1. A computerized method for providing periodic mark trading of financial instruments on a computerized trading system having one or more server computers, the method comprising at least one of the server computers:
receiving a communication from a customer computer on a trading date, the communication including at least one periodic mark limit order, including at least an amount and an indication of a mark time at which a price will be determined for the at least one periodic mark limit order, and placing the received at least one periodic mark limit order in a periodic mark pool;
calculating a periodic mark price from non-periodic mark orders on the book of an FX ECN;
matching the received periodic mark limit order with a compatible other periodic mark limit order in the periodic mark pool; and
after the mark time, executing the matched received periodic mark limit order at the calculated periodic mark price.

2. The computerized method of claim 1, wherein order matching for each periodic mark starts at a predetermined start of matching period time.

3. The computerized method of claim 2, wherein the start of matching period time starts at one from among the group consisting of: (a) the beginning of the trading date; (b) the end of a previous mark time; and (c) as soon as a first periodic mark order is received for a new mark time.

4. The computerized method of claim 1, wherein the calculating of the periodic mark price comprises:
during sampling time periods prior to and after the mark time, taking continuous available liquidity readings within a PIP Range from the top of the book of the FX ECN; and
calculating a pip range average price (PipRAP) based on available liquidity.

5. The computerized method of claim 4, wherein the liquidity readings are taken every time there is a change in composition of the book of the FX ECN within the PIP Range from the top of the book, or, if there have been no changes since the previous reading, at a predetermined default time slice interval between readings.

6. The computerized method of claim 4, wherein the periodic mark price is calculated as an inverted weighted mid-point price using the following formula:
$${P}_{t}^{InvertedWeightedAverage} = \frac{{P}_{t}^{O} \times {V}_{t}^{B} + {P}_{t}^{B} \times {V}_{t}^{O}}{{V}_{t}^{O} + {V}_{t}^{B}}$$
Where:
“P” is the ECN FX Price
“O” is the Offer side
“B” is the Bid side
“V” is the Volume
“t” is the time of the Price.

7. The computerized method of claim 1, wherein in a case when a customer's periodic mark order is not matched at the indicated mark period, the customer is given the option of: (a) cancelling the periodic mark order; (b) moving an unexecuted order to the next periodic mark; or (c) submitting the unexecuted order to the FX ECN for trading.

8. The computerized method of claim 1, wherein the periodic mark liquidity pool operates as a dark pool in which the participants do not know what kind of orders other customers are placing in the pool.

9. The computerized method of claim 1, wherein the periodic mark liquidity pool operates as a grey pool, in which a customer's orders are matched continuously against other customers' orders during a matching period and customers with orders in the periodic mark pool are informed if their orders are matched against other customer orders and only awaiting determination of the price at the mark time.

10. The computerized method of claim 1, wherein the periodic mark order may be a basket order.

11. The computerized method of claim 2, wherein for a basket order the mark price for each periodic mark time will be calculated using periodic mark prices calculated for the same periodic mark time for the basket's underlying currency pairs.

12. The computerized method of claim 1, wherein credit for a customer is reserved for the customer orders when a periodic mark order is placed.

13. The computerized method of claim 1, wherein credit is verified at a time of matching a customer's periodic mark order.

14. A computerized trading system having one or more server computers for providing periodic mark trading of financial instruments, the one or more server computers being configured and programmed to:
receive a communication from a customer computer on a trading date, the communication including at least one periodic mark limit order, including at least an amount and an indication of a mark time at which a price will be determined for the at least one periodic mark limit order, and place the received at least one periodic mark limit order in a periodic mark pool;
calculate a periodic mark price from non-periodic mark orders on a book of an FX ECN;
match the received periodic mark limit order with a compatible other periodic mark limit order in the periodic mark pool; and
after the mark time, execute the matched received periodic mark limit order at the calculated periodic mark price.

15. The computerized trading system of claim 14, wherein order matching for each periodic mark starts at a predetermined start of matching period time.

16. The computerized trading system of claim 15, wherein the start of matching period time starts at one from among the group consisting of: (a) the beginning of the trading date; (b) the end of a previous mark time; and (c) as soon as a first periodic mark order is received for a new mark time.

17. The computerized trading system of claim 14, wherein the calculating of the periodic mark price comprises:
during sampling time periods prior to and after the mark time, taking continuous available liquidity readings within a PIP Range from the top of the book of the FX ECN; and
calculating a pip range average price (PipRAP) based on available liquidity.

18. The computerized trading system of claim 17, wherein the liquidity readings are taken every time there is a change in composition of the book of the FX ECN within the PIP Range from the top of the book, or, if there have been no changes since the previous reading, at a predetermined default time slice interval between readings.

19. The computerized trading system of claim 17, wherein the periodic mark price is calculated as an inverted weighted mid-point price using the following formula:
$${P}_{t}^{InvertedWeightedAverage} = \frac{{P}_{t}^{O} \times {V}_{t}^{B} + {P}_{t}^{B} \times {V}_{t}^{O}}{{V}_{t}^{O} + {V}_{t}^{B}}$$
Where:
“P” is the ECN FX Price
“O” is the Offer side
“B” is the Bid side
“V” is the Volume
“t” is the time of the Price.

20. The computerized trading system of claim 14, wherein in a case when a customer's periodic mark order is not matched at the indicated mark period, the customer is given the option of: (a) cancelling the periodic mark order; (b) moving an unexecuted order to the next periodic mark; or (c) submitting the unexecuted order to the FX ECN for trading.

21. The computerized trading system of claim 14, wherein the periodic mark liquidity pool operates as a dark pool in which the participants do not know what kind of orders other customers are placing in the pool.

22. The computerized trading system of claim 14, wherein the periodic mark liquidity pool operates as a grey pool, in which a customer's orders are matched continuously against other customers' orders during a matching period and customers with orders in the periodic mark pool are informed if their orders are matched against other customer orders and only awaiting determination of the price at the mark time.

23. The computerized trading system of claim 14, wherein the periodic mark order is basket order.

24. The computerized trading system of claim 15, wherein for a basket order the mark price for each periodic mark time is calculated using periodic mark prices calculated for the same periodic mark time for the basket's underlying currency pairs.

25. The computerized trading system of claim 14, wherein credit for a customer is reserved for the customer orders when a periodic mark order is placed.

26. The computerized trading system of claim 14, wherein credit is verified at a time of matching a customer's periodic mark order.
